(19) United States
(12) Patent Application Publication
(10) Pub. No.: US 2019/0279238 A1
(43) Pub. Date: Sep. 12, 2019

(54) INFORMATION PROCESSING SYSTEM, INFORMATION PROCESSING METHOD, AND NON-TRANSITORY COMPUTER-READABLE STORAGE MEDIUM STORING PROGRAM

(71) Applicant: Toyota Jidosha Kabushiki Kaisha, Toyota-shi Aichi-ken (JP)

(72) Inventors: Masahiro Nakano, Nagoya-shi Aichi-ken (JP); Kazuya Nishimura, Okazaki-shi Aichi-ken (JP)

(73) Assignee: Toyota Jidosha Kabushiki Kaisha, Toyota-shi Aichi-ken (JP)

(21) Appl. No.: 16/298,020

(22) Filed: Mar. 11, 2019

(30) Foreign Application Priority Data
Mar. 12, 2018 (JP) 2018-044244

(51) Int. Cl. G06Q 30/02; G06Q 50/30

(52) U.S. Cl. CPC G06Q 30/0205; G06Q 50/30; G06Q 30/0206

(57) ABSTRACT

An information processing system includes a storage unit and a predictor. The storage unit stores area-based demand information on demand for sharing cars and operating rate information on an operating rate of the sharing cars in a first place. The predictor predicts revenue from sharing car rentals in a second place, different from the first place, based on demand information on the demand for the sharing cars in the first place, demand information on the demand for the sharing cars in the second place, and the operating rate information on the operating rate of the sharing cars in the first place.

### CROSS-REFERENCE TO RELATED APPLICATIONS

This application claims priority to Japanese Patent Application No. 2018-044244 filed on Mar. 12, 2018, which is incorporated herein by reference in its entirety including the specification, drawings and abstract.

### BACKGROUND

### 1. Technical Field

The present disclosure relates to an information processing system, an information processing method, and a non-transitory computer-readable storage medium storing a program.

### 2. Description of Related Art

With the development of information communication technology and a change in lifestyle, or for economic reasons, the global trend is moving from an age in which each individual possesses their own goods, to an age in which people share goods collectively in a community. In car-sharing, it is possible for car-sharing members to share sharing cars, check the state of use of the sharing cars, and reserve a sharing car for use, through the internet or the like. Since users can save costs on purchasing, maintaining, parking a car, or the like, by using such car-sharing, compared to owning a car, the number of car-sharing users is on the rise. Meanwhile, a certain level of knowledge on how to efficiently manage the car sharing business is required for a car sharing business operator to generate revenue. For example, when the number of sharing cars exceeds the number of users, the cost for maintaining the sharing cars would be higher than the sales from sharing car rentals, making it difficult to generate revenue. On the contrary, when the number of users exceeds the number of sharing cars, opportunities to generate revenue would be missed. Under such circumstances, Japanese Unexamined Patent Application Publication 2012-181582 (JP 2012-181582 A) proposes a technology to determine whether the number of sharing cars deployed at a car station is appropriate, according to an operating rate of sharing cars.

SUMMARY

However, demand for sharing cars may vary depending on an area, due to various factors (for example, population demographics, traffic environment, or users' taste). Therefore, with the technology disclosed in JP 2012-181582 A, while it may be possible to determine whether the number of sharing cars deployed at a car station is appropriate in an area where the car-sharing business is already developed, it may be difficult to predict the revenue from the car-sharing business with practical accuracy in an area where the business is not yet developed.

The present disclosure proposes an information processing system, an information processing method, and a non-transitory computer-readable storage medium capable of predicting, with practical accuracy, the revenue from the car-sharing business in an area where the business is not yet developed.

An information processing system according to a first aspect of the present disclosure includes a storage unit and a predictor. A storage unit stores area-based demand information on demand for sharing cars, and operating rate information on an operating rate of the sharing cars in a first place. A predictor predicts revenue from sharing car rentals in a second place, different from the first place, based on demand information on demand for the sharing cars in the first place, demand information on demand for the sharing cars in the second place, and the operating rate information on the operating rate of the sharing cars in the first place.

An information processing method according to a second aspect of the present disclosure is executed by a computer system. The information processing method includes a step of storing area-based demand information on demand for sharing cars, and operating rate information on an operating rate of the sharing cars in the first place, and a step of predicting revenue from sharing car rentals in the second place, different from the first place, based on demand information on demand for the sharing cars in the first place, demand information on demand for the sharing cars in the second place, and the operating rate information on the operating rate of the sharing cars in the first place.

A third aspect in the present disclosure relates to a non-transitory computer-readable storage medium storing a program. The program includes commands to cause a computer system to store area-based demand information on demand for sharing cars, and operating rate information on an operating rate of the sharing cars in the first place, and predict revenue from sharing car rentals in the second place, different from the first place, based on demand information on demand for the sharing cars in the first place, demand information on demand for the sharing cars in the second place, and the operating rate information on the operating rate of the sharing cars in the first place.

With each aspect of the present disclosure, it is possible to predict with practical accuracy revenue from sharing car rentals in an area where the business is not yet developed.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 illustrates functional blocks of an information processing system according to an embodiment of the present disclosure;

FIG. 2 is a flowchart illustrating a flow of a prediction process of revenue from sharing car rentals according to an embodiment of the present disclosure; and

FIG. 3 is a diagram to help explain the similarity of demand for sharing cars between areas according to an embodiment of the present disclosure.

### DETAILED DESCRIPTION OF EMBODIMENTS

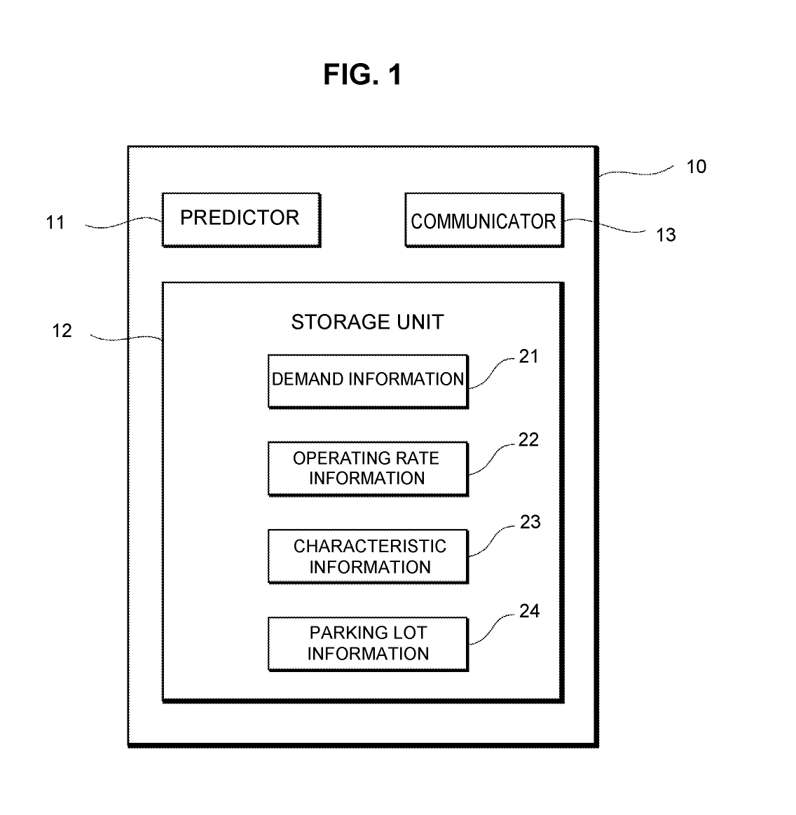

Hereinafter, embodiments of the present disclosure will be described with reference to the drawings. Here, like numerals denote like elements, and a repeated description will be omitted. FIG. 1 is a diagram illustrating functional blocks of an information processing system 10 according to an embodiment of the present disclosure.

The information processing system 10 is a computer system predicting revenue from sharing car rentals. “A sharing car” refers to a vehicle provided for use in car-sharing (for example, shared use among car-sharing members). “A vehicle” includes a vehicle as stated in the Road Traffic Act (for example, a car, a motorcycle, or a lightweight vehicle).

The information processing system 10 includes a processor, a storage device, and a communication module as hardware resources. Stored in the storage device are an information processing program to execute an information processing method that predicts revenue from sharing car rentals, and various types of information used for revenue prediction (for example, demand information 21, operating rate information 22, characteristic information 23, and parking lot information 24 which will be described below). The processor interprets and executes the above information processing program, making the functions of a predictor 11, a storage unit 12, and a communicator 13 be implemented. The function of each of the above elements is implemented by cooperation between the hardware resources of the information processing system 10 and the information processing program. For example, the functions (or processes) of the predictor 11, the storage unit 12, and the communicator 13 are implemented by the processor, the storage device, and the communication module, respectively. The storage device that stores the information processing program is, for example, a computer-readable storage medium such as a semiconductor memory or a disk medium.

In the present specification, for convenience of description, a place where a car-sharing business is already developed (for example, a place of a car station where sharing cars are deployed) is referred to as a “first place”, and a place where a car-sharing business is not yet developed (for example, a candidate place for a car station where deployment of sharing cars is scheduled) is referred to as a “second place”.

The storage unit 12 stores area-based demand information 21 on demand for sharing cars, operating rate information 22 on an operating rate of the sharing cars in the first place, characteristic information 23 which is characteristic of each sharing car in the first place, and parking lot information 24 on a parking lot for the sharing cars in the first place. The storage unit 12 stores the characteristic information 23 of the first place and the parking lot information 24 of the first place, in association with the operating rate information 22 of the first place.

Here, the demand information 21 includes information on any one, or a combination of two or more, of a daytime population, a nighttime population, a car ownership rate, how well a traffic environment and commercial facilities are established, the number of services in competition with the car-sharing service, and the income level of residents, in each area. In areas where there are large daytime or nighttime populations, the demand for the sharing cars tends to be higher than in areas with small daytime populations or nighttime populations. In areas with low car ownership rates, the demand for the sharing cars tends to be higher than in areas with high car ownership rates. In areas where the traffic environment and commercial facilities are well established, the demand for the sharing cars tends to be higher than in areas where the traffic environment and commercial facilities are insufficient. In areas where there are few services in competition with the car-sharing services (for example, transportation such as taxis, rental car, trains, or competing car-sharing services), the demand for the sharing cars tends to higher than in areas where there are many services in competition with the car-sharing services. In areas where residents' income level is high, the demand for the sharing cars tends to be higher than in areas where residents' income level is low. The demand information 21 can be quantitatively evaluated, representing the degree of the demand for the sharing cars statistically in relation to the actual operating rate of the sharing cars.

The demand information 21 that can be evaluated quantitatively as above can be used as an indicator to determine the degree of similarity of demand for the sharing cars between areas. The storage unit 12 may store the demand information 21 regarding the entire area where the car-sharing service can be provided, or a part of the area. Such an area includes the first place and the second place described above.

The operating rate of a sharing car refers to the ratio of the actual rental time of the sharing car (the time a user uses the sharing car) to the available rental time (for example, the business hours of the car station). The characteristic information 23 includes information on type (car name), body color (color of the exterior), or body type (for example, sedan, coupe, cabriolet, wagon, or the like) of the sharing car. The parking lot information 24 includes information on the location conditions of a parking lot (for example, identifying whether the parking lot of the sharing cars is located indoors (inside a building) or outdoors (outside a building).

The predictor 11 predicts the revenue from sharing car rentals in the second place, different from the first place, based on the demand information 21 on the demand for the sharing cars in the first place, the demand information 21 on the demand for the sharing cars in the second place, and the operating rate information 22 on the operating rate of the sharing cars in the first place.

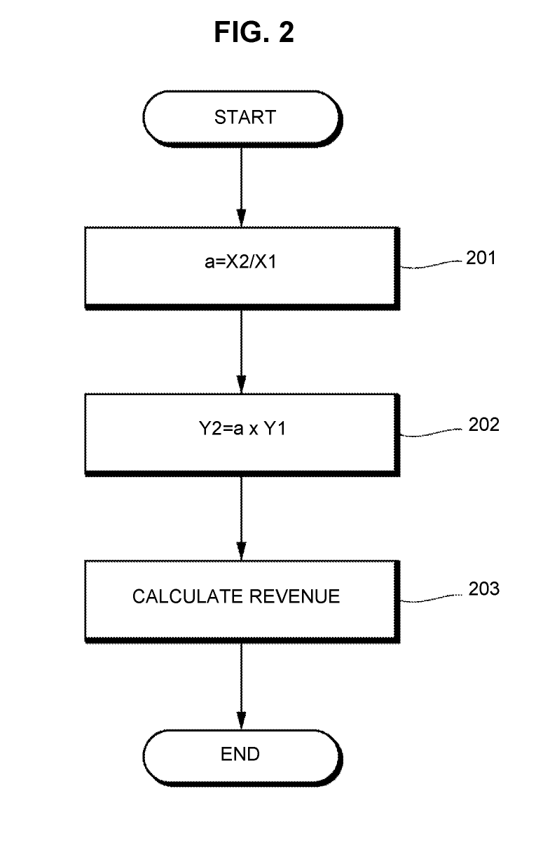

FIG. 2 is a flowchart illustrating a flow of a prediction process of revenue from sharing car rentals. In the description below, it is assumed that the value obtained by quantitatively evaluating the demand information 21 on the demand for the sharing cars in the first place is represented as “X1”, the value obtained by quantitatively evaluating the demand information 21 on the demand for the sharing cars in the second place is represented as “X2”, the degree of similarity of the demand X2 for the sharing cars in the second place to the demand X1 for the sharing cars in the first place, is represented as “a”, the operating rate of the sharing cars in the first place is represented as “Y1”, and the operating rate of the sharing cars in the second place is represented as “Y2”. Further, in order to simplify the description, an example for the revenue prediction is illustrated on the assumption that the demand and the operating rate of the sharing cars are proportionate to each other.

In step 201, the predictor 11 calculates the degree “a” of similarity of the demand X2 to the demand X1 using equation (1). The demand X2 is the demand for the sharing cars in the second place, and the demand X1 is the demand for the sharing cars in the first place.

a=X2/X1 (1)

In step 202, the predictor 11 calculates Y2 using equation (2).

Y2=a×Y1 (2)

For example, when the demand X2 for the sharing cars in the second place, is approximately equal to the demand X1 for the sharing cars in the first place (for example, a=1), the predictor 11 estimates that the operating rate Y2 of the sharing cars in the second place, is approximately the same as the operating rate Y1 of the sharing cars in the first place. For example, when a=1 and Y1=50%, Y2=50% is calculated.

For example, when the demand X2 for the sharing cars in the second place, is lower than the demand X1 for the sharing cars in the first place (in other words, a<1), the predictor 11 estimates that the operating rate Y2 of the sharing cars in the second place, is lower than the operating rate Y1 of the sharing cars in the first place. Here, the predictor 11 estimates that the lower the demand X2 for the sharing cars in the second place, becomes, the lower the operating rate Y2 of the sharing cars in the second place, becomes. For example, when a=0.5 and Y1=50%, Y2=25% is calculated.

For example, when the demand X2 for the sharing cars in the second place, is higher than the demand X1 for the sharing cars in the first place (in other words, when a>1), the predictor 11 estimates that the operating rate Y2 of the sharing cars in the second place, is higher than the operating rate Y1 of the sharing cars in the first place.

Here, the predictor 11 estimates that the higher the demand X2 for the sharing cars in the second place becomes, the higher the operating rate Y2 of the sharing cars in the second place becomes. For example, when a=1.5 and Y1=50%, Y2=75% is calculated.

In step 203, the predictor 11 calculates the revenue from sharing car rentals in the second place from an estimated the operating rate Y2 of the sharing cars in the second place. Here, “revenue” refers to sales and an amount obtained by subtracting expenses (for example, maintenance and labor costs associated with the sharing cars) from the revenue is calculated, as a profit. The maintenance costs for the sharing cars include, for example, parking fees and repair costs on the sharing cars. The predictor 11 may calculate the profit from an estimated revenue from sharing car rentals in the second place.

Further, in the above description, an example calculation of Y2=a×Y1 was illustrated, but the calculation method of the operating rate Y2 is not limited to the above example. For example, the operating rate Y2 may be calculated such that the closer the value of “a” becomes to 1, the closer the value of Y2 becomes to Y1, or may be calculated such that the farther the value of “a” becomes from 1 (i.e., as the difference between the value “a” and 1 becomes greater), the farther the value of Y2 becomes from Y1. For example, under the condition that a=0.9 and Y1=50%, Y2=45% is obtained by calculating Y2=a×Y1. However, since the value of “a” is close to 1, Y2=48% may be obtained, by calculating the value of Y2 to be closer to 50%. Further, for example, under the condition that a=0.1 and Y1=50%, Y2=5% is obtained by calculating Y2=a×Y1. However, since the value of “a” is far from 1 (i.e., the value of “a” is much smaller than 1), Y2=2% may be obtained, by calculating the value of Y2 to be farther from 50%.

Moreover, in the above description, the example of revenue prediction was illustrated on the assumption that the demand and the operating rate of the sharing cars are proportionate to each other. However, the predictor 11 may statistically obtain a relational expression between the demand and the operating rate of the sharing cars, and correct each of the equations (1) and (2) by using the statistically obtained relational expression, to predict the revenue from sharing car rentals in the second place.

The predictor 11 may predict the revenue from sharing car rentals in the second place based on the characteristic information 23 of the sharing cars in the first place and the parking lot information 24 of the sharing cars in the first place, along with the above-described information including the demand information 21 on the demand for the sharing cars in the first place, the demand information 21 on the demand for the sharing cars in the second place, and the operating rate information 22 on the operating rate of the sharing cars in the first place. A popular type, body color, or body type of sharing cars may vary depending on the area. It can be assumed that the operating rate of sharing cars having a popular type, body color, or body type is higher than the operating rate of sharing cars having an unpopular type, body color, or body type. In the similar manner, location conditions of a parking lot of sharing cars can vary depending on the area. The operating rate of the sharing cars parked at an outdoor parking lot is estimated to be higher than the operating rate of the sharing cars parked at an indoor parking lot since the sharing cars parked outdoors are more visible to the public than the sharing cars parked indoors. The operating rate of the sharing cars in the second place can be estimated by the vehicle type, body color, body type, or the location conditions of the parking lot, by additionally considering the characteristic information 23 of the sharing cars in the first place and the parking lot information 24 of the sharing cars in the first place, along with the above-described information (the demand information 21 on the demand for the sharing cars in the first place, the demand information 21 on the demand for the sharing cars in the second place, and the operating rate information 22 of the sharing cars in the first place.) As such, the revenue from sharing car rentals in the second place can be predicted with practical accuracy.

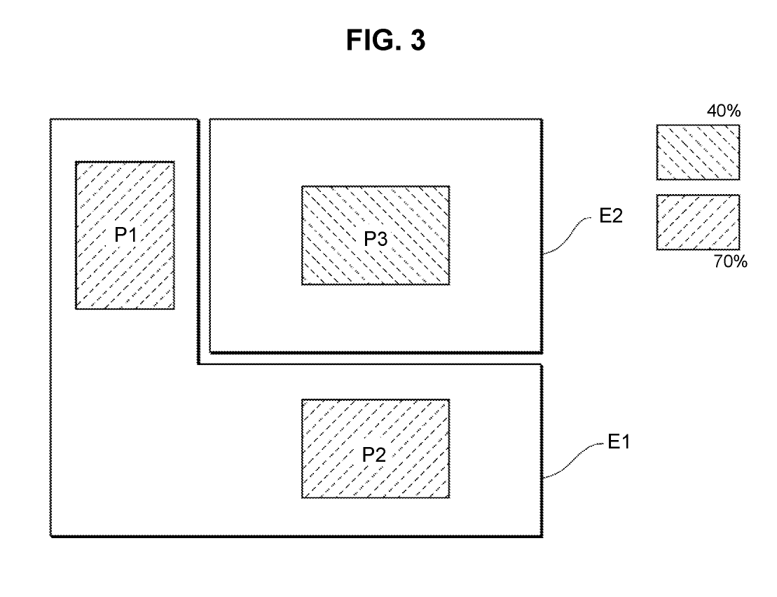

Next, with reference to FIG. 3, the similarity of the demand for the sharing cars between areas will be described. Area E1 is, for example, a city where the traffic environment and commercial facilities are well established, and the population is dense. In this case, the demand for the sharing cars in place P1 in area El and the demand for the sharing cars in place P2 in area E1 are similar to each other and both high to a similar extent. In the example illustrated in FIG. 3, the demand for the sharing cars in place P1 and the demand for the sharing cars in place P2 are 70%. Assuming that the place P1 is the first place and the place P2 is the second place, it can be estimated that the operating rate of the sharing cars in place P2 is approximately the same as the operating rate of the sharing cars in place P1. In such a manner, the revenue from sharing car rentals in place P2 can be predicted with practical accuracy. On the other hand, area E2 is, for example, a sparsely populated area with an insufficient traffic environment or commercial facilities.

In this case, the demand for the sharing cars of place P1 in E1 and the demand for the sharing cars of place P3 in E2 are not similar, and the demand for the sharing cars in place P3 can be estimated to be lower than the demand for the sharing cars in place P1. In the example illustrated in FIG. 3, the demand for the sharing cars in place P3 is 40%.

Assuming that P1 is the first place and P3 is the second place, it can be estimated that the operating rate of the sharing cars in place P3 is lower than the operating rate of the sharing cars in place P1. As such, the revenue from sharing car rentals in place P3 can be predicted with practical accuracy. Moreover, demand for sharing cars at a certain place can be expressed as a proportion of a demand at a place with the highest demand for the sharing cars, which is set as 100%. For example, demand of “70%” and “40%” represent that the demand for the sharing cars at these places amount to 70% and 40%, respectively of the demand at the place which has the highest demand for sharing cars.

In addition, the manager of the information processing system 10 may be a car-sharing business operator providing the car-sharing service himself or herself, or may be an operator who provides a service associated with the operation of the car-sharing service (for example, a service that provides advice on revenue prediction) to the car-sharing business operator. When the manager of the information processing system 10 is the latter, the communicator 13 may provide the information on the revenue prediction of the car-sharing business to a computer system of the car-sharing service owner via a communication network.

The embodiments described above are for the purpose of facilitating understanding of the present disclosure, and are not intended to limit the present disclosure. The embodiments can be modified or improved within the technical scope of the present disclosure, and the present disclosure includes equivalents of the embodiments. For example, the information processing program may include a plurality of software modules called and executed in the main program. Such a software module is a sub-program modularized to execute processing that implements the functions of the predictor 11, the storage unit 12, and the communicator 13. The same functions as those of the above elements may be implemented using dedicated hardware resources (for example, an Application Specific Integrated Circuit (ASIC) or a Field Programmable Gate Array (FPGA)), or firmware. Furthermore, it is possible to encode the information processing program in a designated signal form, and transmit the designated signal from one computer to another via a transmission medium (wired communication network) or a transmission wave (a radio wave). The function of the information processing system 10 may not necessarily be implemented by just one computer, but implemented by a plurality of computers connected to the communication network.

What is claimed is:

1. An information processing system comprising:
a storage unit configured to store area-based demand information on demand for sharing cars, and operating rate information on an operating rate of the sharing cars in a first place; and
a predictor configured to predict revenue from sharing car rentals in a second place, different from the first place, based on demand information on the demand for the sharing cars in the first place, demand information on the demand for the sharing cars in the second place, and the operating rate information on the operating rate of the sharing cars in the first place.

2. The information processing system according to claim 1, wherein:
when the demand for the sharing cars in the second place is the same as the demand for the sharing cars in the first place, the predictor estimates that an operating rate of the sharing cars in the second place is the same as the operating rate of the sharing cars in the first place;
when the demand for the sharing cars in the second place is lower than the demand for the sharing cars in the first place, the predictor estimates that the operating rate of the sharing cars in the second place is lower than the operating rate of the sharing cars in the first place, and that the lower the demand for the sharing cars in the second place becomes, the lower the operating rate of the sharing cars in the second place becomes; and
when the demand for the sharing cars in the second place is higher than the demand for the sharing cars in the first place, the predictor estimates that the operating rate of the sharing cars in the second place is higher than the operating rate of the sharing cars in the first place, and that the higher the demand for the sharing cars in the second place becomes, the higher the operating rate of the sharing cars in the second place becomes; and
the predictor predicts the revenue from sharing car rentals in the second place based on the estimated operating rate in the second place.

3. The information processing system according to claim 1, wherein:
the storage unit stores characteristic information which is characteristic of each of the sharing cars in the first place and parking lot information on a parking lot for the sharing cars in the first place, in association with the operating rate information on the operating rate of the sharing cars in the first place; and
the predictor predicts the revenue from sharing car rentals in the second place, based on further the characteristic information which is characteristic of each of the sharing cars in the first place and the parking lot information on the parking lot for the sharing cars in the first place.

4. The information processing system according to claim 3, wherein:
the characteristic information which is characteristic of each of the sharing cars in the first place includes information on vehicle type, body color, or body type of the sharing cars in the first place;
the parking lot information on the parking lot for the sharing cars in the first place includes information on location conditions of the parking lot for the sharing cars in the first place; and
the area-based demand information includes information on any one, or a combination of two or more, of a daytime population, a nighttime population, car ownership rate, how well a traffic environment and commercial facilities are established, a number of services in competition with a car-sharing service, and an income level of residents, in each area.

5. An information processing method executed by a computer system, the information processing method comprising:
storing area-based demand information on demand for sharing cars, and operating rate information on an operating rate of the sharing cars in a first place; and
predicting revenue from sharing car rentals in a second place, different from the first place, based on demand information on the demand for the sharing cars in the first place, demand information on the demand for the sharing cars in the second place, and the operating rate information on the operating rate of the sharing cars in the first place.

6. A non-transitory computer-readable storage medium storing a program, the program comprising commands to cause a computer system to:
store area-based demand information on demand for sharing cars, and operating rate information on an operating rate of the sharing cars in a first place; and
predict revenue from sharing car rentals in a second place, different from the first place, based on demand information on the demand for the sharing cars in the first place, demand information on the demand for the sharing cars in the second place, and the operating rate information on the operating rate of the sharing cars in the first place.
